(19) United States
(12) Patent Application Publication
(10) Pub. No.: US 2006/0179009 A1
(43) Pub. Date: Aug. 10, 2006

(54) Management of terms and conditions for an agreement

(75) Inventor: Bradley S. Tagg, Chester, NY (US)

Correspondence Address: SCHMEISER, OLSEN & WATTS, 22 CENTURY HILL DRIVE, SUITE 302, LATHAM, NY, 12110, US

(73) Assignee: International Business Machines Corporation, Armonk, NY (US)

(21) Appl. No.: 11/053,377

(22) Filed: Feb. 8, 2005

(51) Int. Cl. G06Q 99/00; H04L 9/00; H04K 1/00

(52) U.S. Cl. 705/80

(57) ABSTRACT

A system and related method for managing terms and conditions for an agreement. The system includes an agreement managing tool. The agreement managing tool is for receiving and revising a copy of a revisable agreement generated by an agreement authoring tool. The copy of the revisable agreement defines a set of terms and conditions related to the offering. The copy of the revisable agreement is received from the agreement authoring tool packaged with the offering.

### BACKGROUND OF THE INVENTION

1. Technical Field

The present invention relates to a system and associated method to manage terms and conditions for an agreement.

2. Related Art

Providing stipulations between parties is typically required when a product is exchanged between the parties. Although stipulations are not typically modifiable, a receiving party may have a need to modify some of the stipulations. Therefore there is a need to provide modifiable stipulations between parties.

### SUMMARY OF THE INVENTION

The present invention provides a system, comprising:

a processing device; and

an agreement authoring tool for generating a revisable agreement and packaging a copy of said revisable agreement with an offering, wherein said revisable agreement defines a set of terms and conditions related to said offering, wherein said processing device is for executing said agreement authoring tool, and wherein said copy of said revisable agreement packaged with said offering is for being transmitted to an agreement manager tool for revising said copy.

The present invention provides a system, comprising:

a processing device; and

an agreement managing tool for receiving and revising a copy of a revisable agreement generated by an agreement authoring tool, wherein said processing device is for executing said agreement manging tool, wherein said copy of said revisable agreement defines a set of terms and conditions related to an offering, and wherein said copy of said revisable agreement is received packaged with said offering.

The present invention provides a method, comprising:

providing a processing device, an agreement authoring tool, and an offering;

executing by said processing device, said agreement authoring tool;

generating by said agreement authoring tool, a revisable agreement defining a set of terms and conditions related to said offering;

packaging by said agreement authoring tool, a copy of said revisable agreement with said offering; and

transmitting by said agreement authoring tool, said copy of said revisable agreement packaged with said offering to an agreement managing tool for revising said copy.

The present invention provides a method, comprising:

providing a system comprising a processing device, an agreement managing tool, and an offering;

receiving by said agreement managing tool, a copy of a revisable agreement generated by an agreement authoring tool, wherein said copy of said revisable agreement defines a set of terms and conditions related to said offering, and wherein said copy of said revisable agreement is received packaged with said offering; and

revising said copy.

The present invention provides a method for deploying computing infrastructure, comprising integrating computer-readable code comprising an agreement authoring tool into a computing system, wherein the code in combination with the computing system is capable of performing the steps of:

generating by said agreement authoring tool, a revisable agreement defining a set of terms and conditions related to an offering;

packaging by said agreement authoring tool, a copy of said revisable agreement with said offering; and

transmitting by said agreement authoring tool, said copy of said revisable agreement packaged with said offering to an agreement managing tool for revising said copy.

The present invention provides a method for deploying computing infrastructure, comprising integrating computer-readable code comprising an agreement managing tool into a computing system, wherein the code in combination with the computing system is capable of performing the steps of:

receiving by said agreement managing tool, a copy of a revisable agreement generated by an agreement authoring tool, wherein said copy of said revisable agreement defines a set of terms and conditions related to an offering, and wherein said copy of said revisable agreement is received packaged with said offering; and

revising said copy.

The present invention provides a computer program product, comprising a computer usable medium having a computer readable program code embodied therein for implementing a method, wherein said computer readable program code comprises an agreement authoring tool adapted to implement the method by executing the steps of:

generating by said agreement authoring tool, a revisable agreement defining a set of terms and conditions related to an offering;

packaging by said agreement authoring tool, a copy of said revisable agreement with said offering; and

transmitting by said agreement authoring tool, said copy of said revisable agreement packaged with said offering to an agreement managing tool for revising said copy.

The present invention provides a computer program product, comprising a computer usable medium having a computer readable program code embodied therein for implementing a method, wherein said computer readable program code comprises an agreement managing tool adapted to implement the method by executing the steps of:

receiving by said agreement managing tool, a copy of a revisable agreement generated by an agreement authoring tool, wherein said copy of said revisable agreement defines a set of terms and conditions related to an offering, and wherein said copy of said revisable agreement is received packaged with said offering; and

revising said copy.

The present invention provides advantageously provides a system and associated method to provide modifiable stipulations between parties.

### BRIEF DESCRIPTION OF THE DRAWINGS

FIG. 1 illustrates a block diagram of a computing system, in accordance with embodiments of the present invention.

FIG. 2 illustrated in sections represented by FIGS. 2A, 2B, and 2C illustrates a block diagram comprising process flows of components within a software system, in accordance with embodiments of the present invention.

FIG. 3 is a flowchart illustrating an algorithm for installing and using the agreement authoring tool of FIG. 2, in accordance with embodiments of the present invention.

FIG. 4 is a flowchart illustrating an algorithm related to a first step in FIG. 3, in accordance with embodiments of the present invention.

FIG. 5 is a flowchart illustrating an algorithm for a second step of FIG. 3, in accordance with embodiments of the present invention.

FIG. 6 is a flowchart illustrating an algorithm for installing and using the agreement managing tool of FIG. 2, in accordance with embodiments of the present invention.

FIG. 7 is a flowchart illustrating an algorithm for implementing the local policy managing tool of FIG. 2, in accordance with embodiments of the present invention.

FIG. 8 is a flowchart illustrating an algorithm for implementing the enterprise policy managing tool of FIG. 2, in accordance with embodiments of the present invention.

FIG. 9 illustrates a computer system used for implementing the agreement authoring tool and agreement managing tool of the present invention.

### DETAILED DESCRIPTION OF THE INVENTION

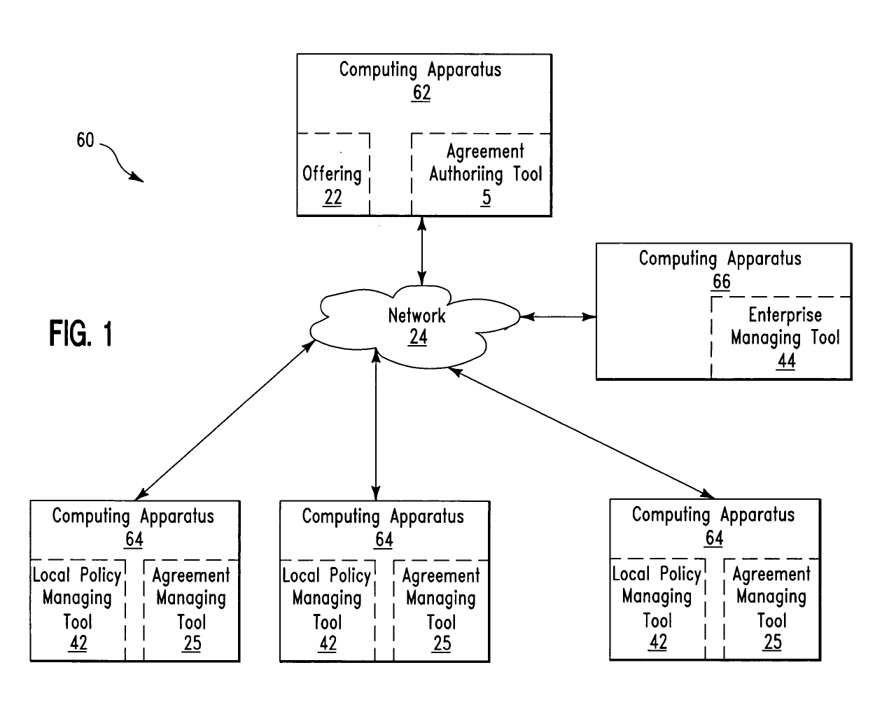

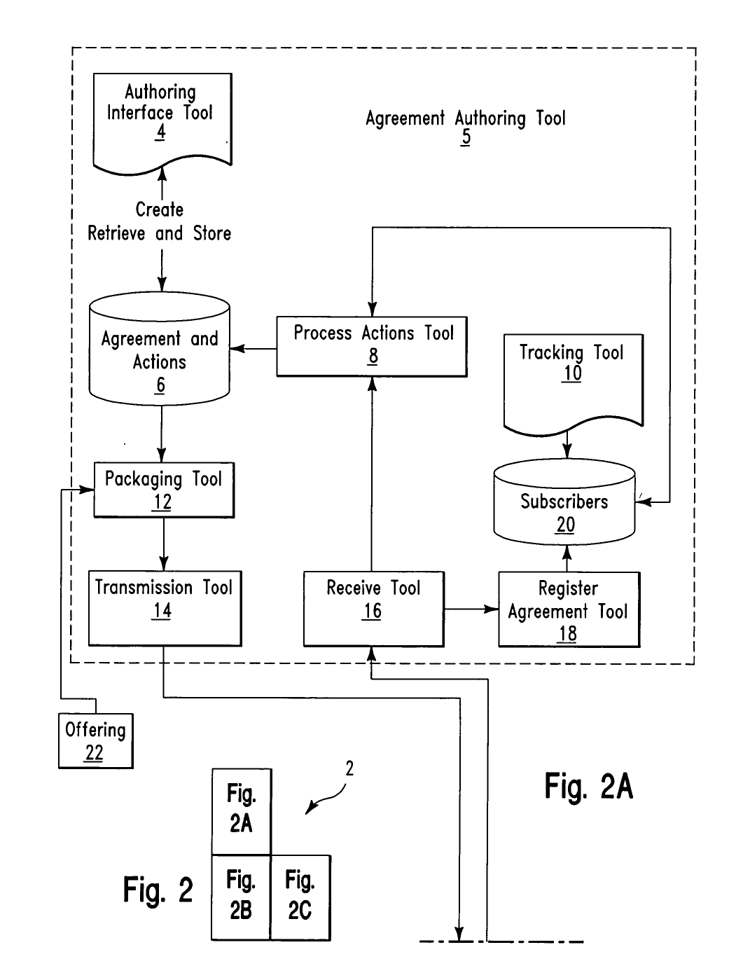

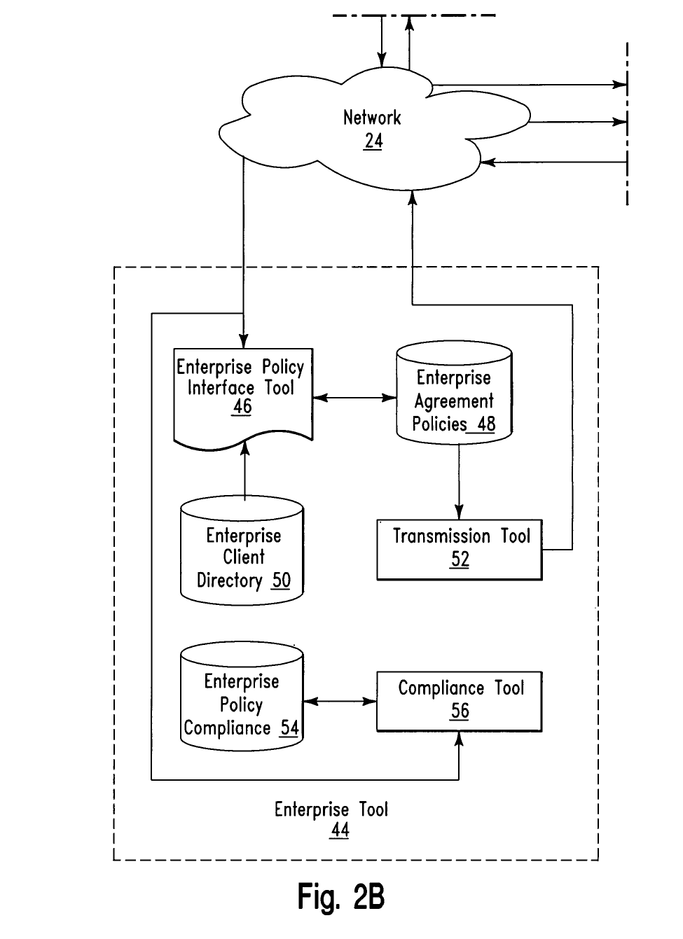

FIG. 1 illustrates a block diagram of a computing system 60, in accordance with embodiments of the present invention. The computing system 60 comprises computing apparatuses 62, 66, and a plurality of computing apparatuses 64. The computing apparatus 62 is electrically connected to the plurality of computing apparatuses 64 through a network 24. The computing apparatus 66 is electrically connected to the plurality of computing apparatuses 64 through the network 24. The plurality of computing apparatuses 64 may comprise only one computing apparatus or a plurality of computing apparatuses as shown in FIG. 1. The computing system 60 implements a software system 2 (see FIG. 2) for generating a revisable agreement between a provider of an offering and a receiver of the offering. The agreement specifies terms and conditions related to the offering. An offering may include, inter alia, a software product, a component of a software product (e.g., a web service), an internet service, etc. The software system 2 comprises comprises four main software components: an agreement authoring tool 5, an agreement managing tool 25, an enterprise policy managing tool 44, and a local policy managing tool 42. The revisable agreement may comprise revisable terms and conditions that are predefined by the agreement authoring tool 5. Alternatively, the revisable agreement may comprise revisable terms and conditions that are negotiable between the agreement authoring tool 5 and the agreement managing tool 25. The software system 2 is described in detail in the description of FIG. 2.

FIG. 2 illustrates a block diagram comprising process flows of components within a software system 2, in accordance with embodiments of the present invention. The block diagram of FIG. 2 is illustrated in sections represented by FIGS. 2A, 2B, and 2C. The software system 2 is implemented using a computing system (e.g., see computing system 60 in FIG. 1). In a networking environment, providers (e.g., a company) offer (e.g., offer to sell, offer to sell for a finite amount of time, offer free trials, etc.) over a network (e.g., the Internet, an intranet, etc.) offerings (e.g., offering 22) to a customer (i.e., a receiving party). A customer may be, inter alia, a single customer comprising a single user for the offering, a company comprising multiple users for the offering, etc. An offering may include, inter alia, a software product, a component of a software product (e.g., a web service), an internet service, etc. Before a customer receives an offering, an agreement specifying terms and conditions related to the offering should be generated between the provider and the customer. Examples of terms and conditions may be, inter alia, specified uses for the offering 22, abiding by copyright laws regarding the offering 22, a specific timeframe that the offering 22 is valid, etc. The software system 2 provides a provider with a means for creating the agreement. The software system 2 additionally provides a customer with a means for revising the agreement before and/or after accepting the agreement.

The software system 2 comprises four main software components: an agreement authoring tool 5, an agreement managing tool 25, an enterprise policy managing tool 44, and a local policy managing tool 42. The agreement authoring tool 5 communicates with (e.g., passes information, data, etc.) the agreement managing tool 25 through a network 24. The agreement managing tool 25 communicates with (e.g., passes information, data, etc.) the enterprise policy managing tool 44 through the network 24. The enterprise policy managing tool 44 communicates with (e.g., passes information, data, etc.) the local policy managing tool 44 through the network 24. The agreement authoring tool 5 is located on a first computing apparatus (e.g., see computing apparatus 62 in FIG. 1). The agreement managing tool 25 and the local policy managing tool 44 are located on a second computing apparatus or plurality of computing apparatuses (e.g., see computing apparatuses 64 in FIG. 1). The enterprise policy managing tool 44 is located on a third computing apparatus (e.g., see computing apparatus 66 in FIG. 1). The first, second, and third computing apparatuses are electrically connected to each other through the network 24.

The agreement authoring tool 5 is responsible for generating and managing agreements and associated actions related to the agreements. An action is defined herein as a function that is related to the agreement and is performed on specific terms and conditions of the agreement by a customer. For example, an action may comprise, inter alia, accepting or declining the agreement, extending the agreement, changing terms of the agreement, etc. The agreement authoring tool 5 is typically installed on a computing apparatus (e.g., see computing apparatus 62 in FIG. 1) managed by the provider that is providing the offering 22. The agreement authoring tool 5 comprises an authoring interface tool 4 to interface the provider to the agreement authoring tool 5. The authoring interface tool 4 allows the provider to list, view, manage, and create the agreements and associated actions. The agreements and associated actions are stored persistently as a master copy in an agreements and actions database 6. A packaging tool 12 retrieves a copy of the agreement along with the associated actions and creates a package comprising the copy, the associated action(s), and the offering 22. A transmission tool 14 transmits the package over the network 24 to the agreement managing tool 25 so that the customer may execute the associated action(s) on the copy of the agreement as described infra. The agreement managing tool 25 is typically installed on a computing apparatus or plurality of computing apparatuses (e.g., see plurality of computing apparatuses 64 in FIG. 1) managed by the customer that is receiving the offering 22. After the customer executes the associated action(s) on the copy of the agreement, the copy along with the executed action(s) are transmitted from agreement managing tool 25 to a receiving tool 16 within the agreement authoring tool 5. If the copy of the agreement along with the executed action(s) is received by the receiving tool 16 for a first time, a registration defining the customer as a subscriber is created by a registration tool 18 and the registration is stored in a subscriber database 20. A tracking tool 10 is used to manage the subscriber database 20. After the customer is registered as a subscriber, the executed actions may be processed by a process actions tool 8. The executed actions will not be processed by the process actions tool 8 until the process actions tool 8 verifies with the subscriber database 20 that the customer is a subscriber. The process actions tool 8 then processes the executed actions and transmits the copy and the processed actions to the agreements and actions database 6 for storage and/or future use. The copy of the agreement may be transmitted between the agreement authoring tool 5 and the agreement managing tool 25 a desired number of times, each time different actions may be executed by the agreement managing tool 25 and processed by the agreement authoring tool 5. Each time the copy passes between the agreement authoring tool 5 and the agreement managing tool 25, the terms and conditions related to the offering are revised according to the processed actions.

The agreement managing tool 25 is responsible for receiving the package comprising the copy, the associated action(s), and the offering 22 and allowing the customer to execute the actions generated by the agreement authoring tool 5. The agreement managing tool 25 comprises a receive tool 26 for receiving the package. The offering 22 is sent to a database 57 for storage until the agreement managing tool 25 executes the actions. The copy of the agreement and the associated action(s) are sent to an agreements and actions database 30. An agreement manager interface tool 28 allows the customer to list, view and manage agreement(s). An events and actions interface tool 32 allows a customer to retrieve the copy of the agreement and the associated action(s) from the agreements and actions database 30 and send the copy of the agreement and the associated action(s) to an execute actions tool 34 for execution of the actions. The executed actions are sent back to the agreement authoring tool 5. The software system may additionally comprise an enterprise policy managing tool 44 and a local policy managing tool 42 to enforce enterprise and local policies prior to execution of the actions.

The enterprise policy managing tool 44 provides an ability to define default agreement settings which all agreement managing tools 25 that are bound to the enterprise policy managing tool 44 must adhere to (e.g., global policies related to all employees within a business). An enterprise policy interface tool 46 is provided to author conditions which define default limits (e.g., global enterprise policies) as to what all users of the agreement managing tools 25 may agree to. These default limits are transmitted to all agreement managing tools 25 that have been bound to the enterprise policy interface tool 46. An enterprise client directory 50 tracks which agreement managing tools 25 are bound to enterprise policy interface tool 46 and a transmission tool 52 transmits the default limits to all of the agreement managing tools 25 that are bound to the enterprise policy interface tool 46. As agreement managing tools 25 are used to execute actions, the executed actions are tracked for compliance to enterprise policies by a compliance tool 56 and stored in an enterprise policy compliance database 54.

The local policy managing tool 44 provides a local user of the agreement managing tool 25 the ability to their own defaults and limits (i.e., local policies) on choices provided by the actions. The local policy managing tool 44 comprises a cache 40 for storing global enterprise policies sent by the enterprise policy managing tool 44 as a hierarchal relationship exists such that said enterprise policies are implemented before the local policies are implemented. The local policy managing tool 44 enforces the enterprise policies and the local policies before the agreement managing tool 25 may execute the actions. The local policy managing tool 44 comprises a local agreement policy interface tool 36 for interfacing a user of the local computing apparatus(s) (e.g., plurality of computing apparatuses 64 in FIG. 1) to list, view, create and manage local agreement policy choices and store the local policies in a local agreement policy database 38. All actions that are attempted to be processed by the user of the local computing apparatus are analyzed by the local policy managing tool 44 against the enterprise policies from the enterprise policy managing tool 44 and local policies from the local policy managing tool 44. Actions executed by the agreement managing tool 25 are tracked, logged and sent to the enterprise policy managing tool 44 for tracking and management by the enterprise policy managing tool 44.

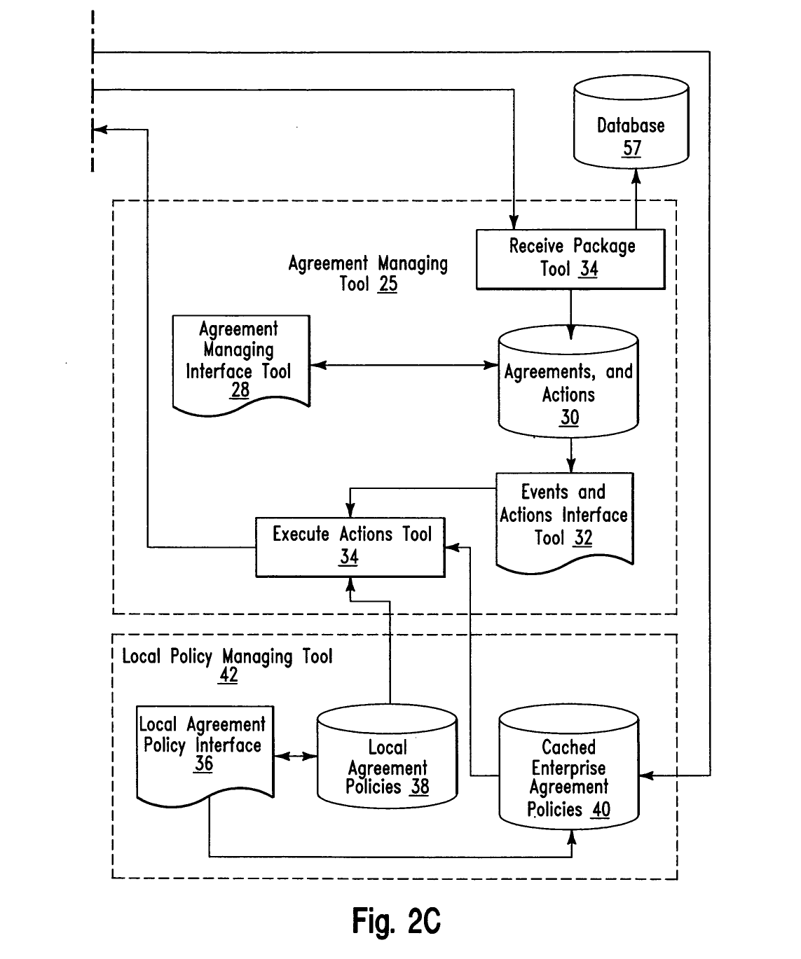

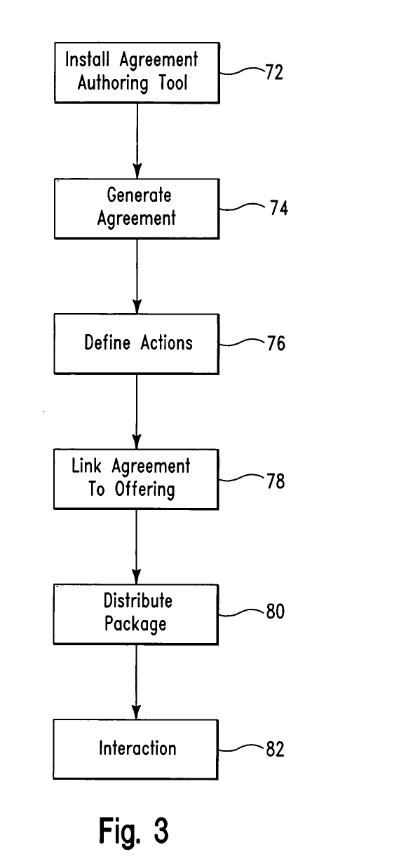

FIG. 3 is a flowchart illustrating an algorithm for installing and using the agreement authoring tool 5 of FIG. 2, in accordance with embodiments of the present invention. In step 72, the agreement authoring tool is installed on a computing apparatus managed by the provider of an offering. The agreement authoring tool will be used to generate agreements related to an offering between a provider of the offering and a receiving party of the offering. In step 74, an agreement(s) is generated. The agreement(s) are managed with an interface tool (e.g., authoring interface tool 4 of FIG. 2) that allows the author of agreements (i.e., the provider) to manage and develop agreements. In step 76, actions related to the agreement are generated. In step 78, the agreement, actions, and offering are linked together to create a package. A single agreement can be associated to a plurality of offerings. In step 80, the agreement authoring tool is used to distribute (make available) the package to an agreement managing tool (e.g., agreement managing tool of FIG. 2) for execution of the actions. The agreement managing tool may be located on a plurality of computing apparatuses. In step 82, the agreement authoring tool is used to interact with and exchange copies of the agreement and actions between local agreement managing tools that have received copies of agreement(s) and associated actions and the agreement authoring tool that was used to generate the agreement and associated actions that define future interactions allowed by the agreement.

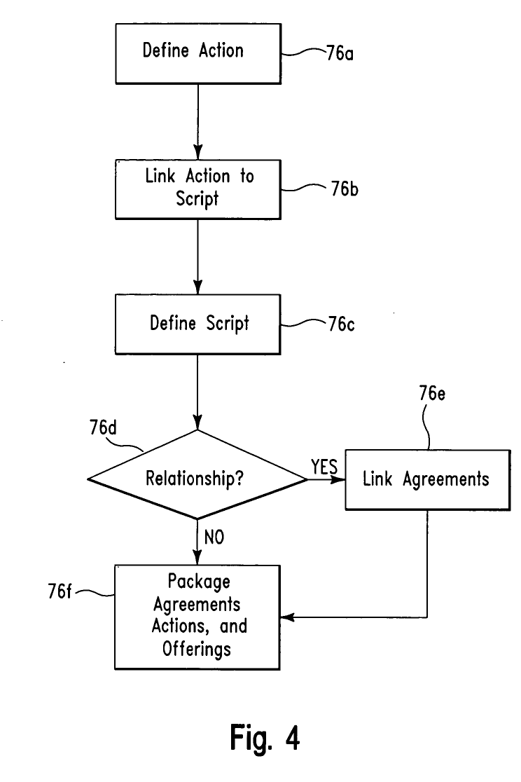

FIG. 4 is a flowchart illustrating an algorithm for step 76 of FIG. 3, in accordance with embodiments of the present invention. In step 76a, an action and related execution script is defined. An execution script is defined herein as a sequence of steps comprised by the action to be executed by the agreement managing tool. In step 76b, the action is linked to the execution script and a related event (i.e., a related portion of the agreement) so that the action may be executed by the agreement managing tool. In step 76d, it is determined if relationships exist between execution scripts comprised by different actions from different agreements. If it is determined that a relationship exists in step 76d, then in step 76e the agreements comprising the relationships are linked together with their associated actions, events and scripts. In step 76f, the agreement(s), actions, and offerings are packaged together for transmission. If it is not determined that a relationship exists in step 76d, then step 76f is executed immediatly following step 76d.

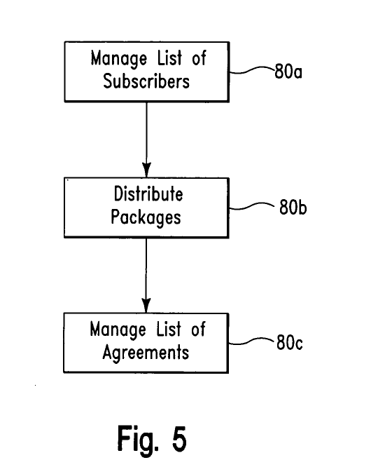

FIG. 5 is a flowchart illustrating an algorithm for step 80 of FIG. 3, in accordance with embodiments of the present invention. In step 80a, the agreement authoring tool provides support for managing a list of subscribers to an agreement, based on messages exchanged when a customer (i.e., receiver) recieves the offering, accepts the agreement, and becomes a subscriber. In step 80b, the agreement authoring tool distributes a copy of the agreement and its associated actions to the customer that accepted the agreement. In step 80c, the agreement authoring tool manages a list of different agreements that were sent to different agreement managing tools and uses this list for future maintenance of the agreements.

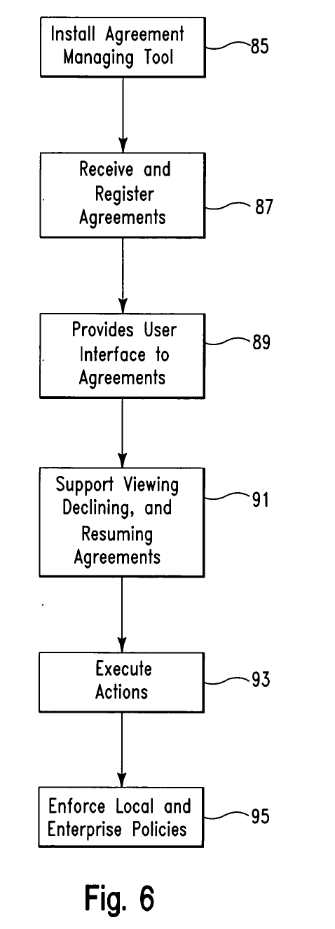

FIG. 6 is a flowchart illustrating an algorithm for installing and using the agreement managing tool 25 of FIG. 2, in accordance with embodiments of the present invention. In step 85, the agreement managing tool is installed on a local computing apparatus(s) (e.g., computing apparatuses 64 in FIG. 1). In step 87, the agreement managing tool receives and registers agreements from an agreement authoring tool. In step 89, the agreement managing tool displays and provides a user interface on the local computing apparatus. The interface allows the user (i.e., customer) of the local computing apparatus to manage agreements. In step 91, the agreement managing tool provides support for the user of the local computing apparatus, allowing the user to view, accept, decline, and act on actions provided as associated to the agreements coming from the agreement authoring tool. In step 93, the agreement managing tool allows the user of the local computing apparatus to interact execute the actions associated to the agreements. In step 95, the agreement managing tool checks and enforces policies set by the local policy managing tool (e.g., local policy managing tool 42 in FIG. 2) and policies set by the enterprise policy managing tool (e.g., enterprise policy managing tool 44 in FIG. 2) associated to the local computing apparatus.

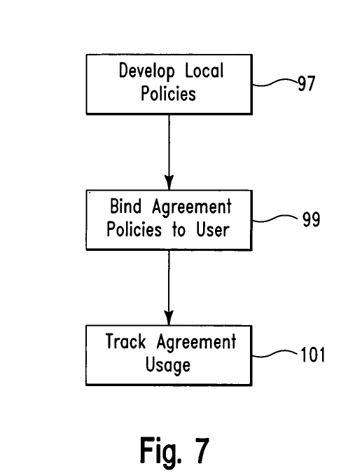

FIG. 7 is a flowchart illustrating an algorithm for implementing the local policy managing tool 42 of FIG. 2, in accordance with embodiments of the present invention. In step 97, the local policy managing tool 42 allows the user of the local computing apparatus to create and manage policies that will act as defaults related to actions for agreements. In step 99, the local policy managing tool 42 allows the user of the local computing apparatus to associate or bind the policies that they create to be in effect whenever the user is a recognized user of the local computing apparatus. In step 101, the local policy managing tool 42 allows the user of the local computing device to track how the policies are used and enforced during the acceptance of agreements.

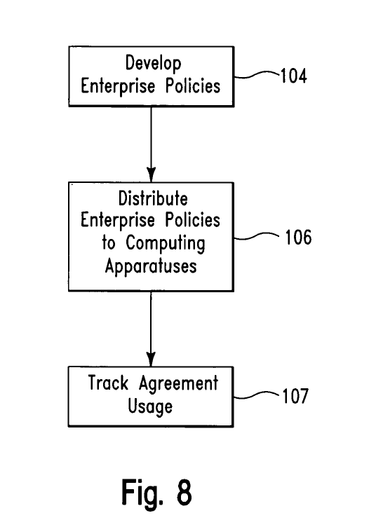

FIG. 8 is a flowchart illustrating an algorithm for implementing the enterprise policy managing tool 44 of FIG. 2, in accordance with embodiments of the present invention. In step 104, the enterprise policy managing tool 44 allows a proxy for the enterprise (governing party) to create and manage enterprise policies that will act as defaults related to choices about agreements. In step 106, the enterprise policy managing tool 44 allows the proxy for the enterprise to manage a list of local computing apparatuses under its jurisdiction. This list is used to distribute enterprise agreement policies to the local computing apparatuses in its jurisdiction list. In step 107, the enterprise policy managing tool 44 allows the user of the local computing apparatus to track how the policies are used and enforced during the acceptance of agreements.

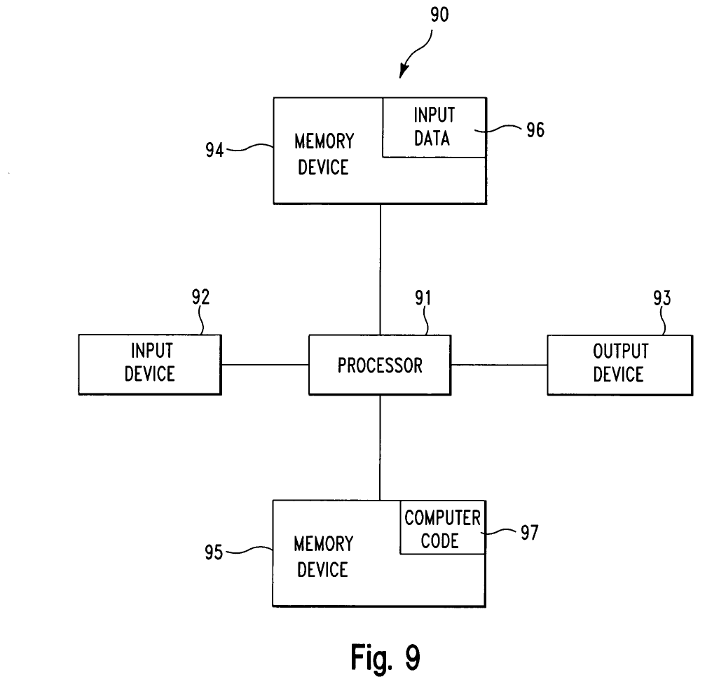

FIG. 9 illustrates a computer system 90 used for implementing the agreement authoring tool 5 and agreement managing tool 25 of the present invention. The computer system 90 comprises a processor 91, an input device 92 coupled to the processor 91, an output device 93 coupled to the processor 91, and memory devices 94 and 95 each coupled to the processor 91. The input device 92 may be, inter alia, a keyboard, a mouse, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97. The computer code 97 includes algorithm(s) for implementing the the agreement authoring tool 5 and agreement managing tool 25 of the present invention. The processor 91 executes the computer code 97. The memory device 94 includes input data 9. The memory device 94 memory device 95, and the processor 91 may relate to the computing apparatuses 62, 64, and 66 of FIG. 1. The input data 96 includes input required by the computer code 97. The output device 93 displays output from the computer code 97. Either or both memory devices 94 and 95 (or one or more additional memory devices not shown in FIG. 4) may be used as a computer usable medium (or a computer readable medium or a program storage device) having a computer readable program code embodied therein and/or having other data stored therein, wherein the computer readable program code comprises the computer code 97. Generally, a computer program product (or, alternatively, an article of manufacture) of the computer system 90 may comprise said computer usable medium (or said program storage device).

Thus the present invention discloses a process for deploying or integrating computing infrastructure, comprising integrating computer-readable code into the computer system 90, wherein the code in combination with the computer system 90 is capable of performing a method for providing the agreement authoring tool 5 and agreement managing tool 25 of FIGS. 1 and 2.

While FIG. 9 shows the computer system 90 as a particular configuration of hardware and software, any configuration of hardware and software, as would be known to a person of ordinary skill in the art, may be utilized for the purposes stated supra in conjunction with the particular computer system 90 of FIG. 9. For example, the memory devices 94 and 95 may be portions of a single memory device rather than separate memory devices.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A system, comprising:
a processing device; and
an agreement authoring tool for generating a revisable agreement and packaging a copy of said revisable agreement with an offering, wherein said revisable agreement definines a set of terms and conditions related to said offering, wherein said processing device is for executing said agreement authoring tool, and wherein said copy of said revisable agreement packaged with said offering is for being transmitted to an agreement manager tool for revising said copy.

2. The system of claim 1, wherein said agreement authoring tool comprises an authoring interface tool for generating said revisable agreement and generating at least one associated action related to said revisable agreement, and wherein said at least one associated action is for said agreement managing tool to perform an action on said copy.

3. The system of claim 2, wherein said agreement authoring tool further comprises a packaging tool for packaging said offering with said copy and said at least one associated action.

4. The system of claim 3, wherein said agreement authoring tool further comprises a tracking tool for registering and managing a user of said agreement managing tool.

5. The system of claim 3, wherein said agreement authoring tool further comprises a process actions tool for processing said at least one associated action on said copy performed by said agreement managing tool.

6. The system of claim 1, wherein said offering is selected from the group consisting of a software product and a software service.

7. The system of claim 1, wherein said copy of said revisable agreement packaged with said offering is transmitted to said agreement managing interface tool over a computer network.

8. A system, comprising:
a processing device; and
an agreement managing tool for receiving and revising a copy of a revisable agreement generated by an agreement authoring tool, wherein said processing device is for executing said agreement manging tool, wherein said copy of said revisable agreement defines a set of terms and conditions related to an offering, and wherein said copy of said revisable agreement is received packaged with said offering.

9. The system of claim 8, wherein said copy comprises at least one associated action for performing an action on said copy.

10. The system of claim 9, wherein said agreement managing tool comprises an agreement managing user interface tool for receiving said copy packaged with said offering and interfacing a user to said copy.

11. The system of claim 10, wherein said agreement managing tool further comprises an actions interface tool for performing said specified action on said copy.

12. The system of claim 11, wherein said system further comprises an enterprise agreement policy managing tool for defining enterprise policies related to performing said specified action on said copy.

13. The system of claim 12, wherein said software system further comprises a local agreement managing tool for defining local policies related to performing said specified action on said copy.

14. The system of claim 13, wherein a hierarchal relationship exists such that said enterprise policies are implemented before said local policies are implemented.

15. The system of claim 13, wherein said agreement managing tool further comprises a transmission tool for transmitting copy comprising said performed specified action to said agreement authoring tool.

16. The system of claim 8, wherein said offering is selected from the group consisting of a software product and a software service.

17. The system of claim 8, wherein said copy of said revisable agreement packaged with said offering is received by said agreement managing tool over a computer network.

18. A method, comprising:
providing a processing device, an agreement authoring tool, and an offering;
executing by said processing device, said agreement authoring tool;
generating by said agreement authoring tool, a revisable agreement defining a set of terms and conditions related to said offering;
packaging by said agreement authoring tool, a copy of said revisable agreement with said offering; and
transmitting by said agreement authoring tool, said copy of said revisable agreement packaged with said offering to an agreement managing tool for revising said copy.

19. The method of claim 18, wherein said agreement authoring tool comprises an authoring interface tool, and wherein said method further comprises:
generating by said agreement authoring tool, said revisable agreement; and
generating by said agreement authoring tool, at least one associated action related to said revisable agreement, wherein said at least one associated action is for said agreement managing tool to perform an action on said copy.

20. The method of claim 19, wherein said agreement authoring tool further comprises a packaging tool; and wherein said method further comprises:
creating a package by said packaging tool, wherein said package comprises said offering with said copy and said at least one associated action.

21. The method of claim 20, further comprising transmitting said package to said agreement managing tool.

22. The method of claim 21, further comprising receiving by said agreement authoring tool, said copy from said agreement managing tool, wherein said copy has been revised by said agreement managing tool according to said at least one associated action.

23. The method of claim 22, wherein said agreement authoring tool further comprises a tracking tool; and wherein said method further comprises:
registering and managing by said tracking tool, a user of said agreement managing tool.

24. The method of claim 23, wherein said agreement authoring tool further comprises a process actions tool, and wherein said method further comprises:
processing by said process actions tool, said at least one associated action on said copy revised by said agreement managing tool.

25. The method of claim 18, wherein said offering is selected from the group consisting of a software product and a software service.

26. The method of claim 18, wherein said copy of said revisable agreement packaged with said offering transmitted to said agreement managing interface tool over a computer network.

27. A method, comprising:
providing a system comprising a processing device, an agreement managing tool, and an offering;
receiving by said agreement managing tool, a copy of a revisable agreement generated by an agreement authoring tool, wherein said copy of said revisable agreement defines a set of terms and conditions related to said offering, and wherein said copy of said revisable agreement is received packaged with said offering; and
revising said copy.

28. The method of claim 27, wherein said copy comprises at least one associated action for performing an action on said copy.

29. The method of claim 28, wherein said agreement managing tool comprises an agreement managing user interface tool, and wherein said method further comprises:
interfacing by said user interface tool, a user to said copy packaged with said offering.

30. The method of claim 29, wherein said system further comprises an enterprise agreement policy managing tool, and wherein said method further comprises:
defining by said enterprise agreement policy managing tool, enterprise policies related to performing said specified action on said copy.

31. The method of claim 30, wherein said system further comprises a local agreement managing tool, and wherein said method further comprises:
defining by said local agreement managing tool, local policies related to performing said specified action on said copy.

32. The method of claim 31, wherein a hiearchal relationship exists such that said enterprise policies are implemented before said local policies are implemented.

33. The method of claim 31, wherein said agreement managing tool further comprises an actions interface tool, and wherein said method further comprises:
performing by said actions interface tool, said action on said copy according to said enterprise policies and said local policies.

34. The method of claim 34, wherein said agreement managing tool further comprises a transmission tool, and wherein said method further comprises:
transmitting by said transmission tool, said copy comprising said performed specified action to said agreement authoring tool.

35. The method of claim 27, wherein said offering is selected from the group consisting of a software product and a software service.

36. The method of claim 27, wherein said copy of said revisable agreement packaged with said offering is received by said agreement managing tool over a computer network.

37. A method for deploying computing infrastructure, comprising integrating computer-readable code comprising an agreement authoring tool into a computing system, wherein the code in combination with the computing system is capable of performing the steps of:
generating by said agreement authoring tool, a revisable agreement defining a set of terms and conditions related to an offering;
packaging by said agreement authoring tool, a copy of said revisable agreement with said offering; and
transmitting by said agreement authoring tool, said copy of said revisable agreement packaged with said offering to an agreement managing tool for revising said copy.

38. The method of claim 37, wherein said agreement authoring tool comprises an authoring interface tool, and wherein said method further comprises:
generating by said agreement authoring tool, said revisable agreement; and
generating by said agreement authoring tool, at least one associated action related to said revisable agreement, wherein said at least one associated action is for said agreement managing tool to perform an action on said copy.

39. The method of claim 38, wherein said agreement authoring tool further comprises a packaging tool; and wherein said method further comprises:
creating a package by said packaging tool, wherein said package comprises said offering with said copy and said at least one associated action.

40. The method of claim 39, further comprising transmitting said package to said agreement managing tool.

41. The method of claim 40, further comprising receiving by said agreement authoring tool, said copy from said agreement managing tool, wherein said copy has been revised by said agreement managing tool according to said at least one associated action.

42. The method of claim 41, wherein said agreement authoring tool further comprises a tracking tool; and wherein said method further comprises:
registering and managing by said tracking tool, a user of said agreement managing tool.

43. The method of claim 42, wherein said agreement authoring tool comprises a process actions tool, and wherein said method further comprises:
processing by said process actions tool, said at least one associated action on said copy revised by said agreement managing tool.

44. The method of claim 37, wherein said offering is selected from the group consisting of a software product and a software service.

45. The method of claim 37, wherein said copy of said revisable agreement packaged with said offering is transmitted to said agreement managing interface tool over a computer network.

46. A method for deploying computing infrastructure, comprising integrating computer-readable code comprising an agreement managing tool into a computing system, wherein the code in combination with the computing system is capable of performing the steps of:
receiving by said agreement managing tool, a copy of a revisable agreement generated by an agreement authoring tool, wherein said copy of said revisable agreement defines a set of terms and conditions related to an offering, and wherein said copy of said revisable agreement is received packaged with said offering; and
revising said copy.

47. The method of claim 46, wherein said copy comprises at least one associated action for performing an action on said copy.

48. The method of claim 47, wherein said agreement managing tool comprises an agreement managing user interface tool, and wherein said method further comprises:
interfacing by said user interface tool, a user to said copy packaged with said offering.

49. The method of claim 48, wherein said computer-readable code further comprises an enterprise agreement policy managing tool, and wherein said method further comprises:
defining by said enterprise agreement policy managing tool, enterprise policies related to performing said action on said copy.

50. The method of claim 49, wherein said computer-readable code further comprises a local agreement managing tool, and wherein said method further comprises:
defining by said local agreement managing tool, local policies related to performing said specified action on said copy.

51. The method of claim 50, wherein a hiearchal relationship exists such that said enterprise policies are implemented before said local policies are implemented.

52. The method of claim 51, wherein said agreement managing tool further comprises an actions interface tool, and wherein said method further comprises:
performing by said actions interface tool, said action on said copy according to said enterprise policies and said local policies.

53. The method of claim 52, wherein said agreement managing tool further comprises a transmission tool, and wherein said method further comprises:
transmitting by said transmission tool, said copy comprising said performed specified action to said agreement authoring tool.

54. The method of claim 46, wherein said offering is selected from the group consisting of a software product and a software service.

55. The method of claim 46, wherein said copy of said revisable agreement packaged with said offering is received by said agreement managing tool over a computer network.

56. A computer program product, comprising a computer usable medium having a computer readable program code embodied therein for implementing a method, wherein said computer readable program code comprises an agreement authoring tool adapted to implement the method by executing the steps of:
generating by said agreement authoring tool, a revisable agreement defining a set of terms and conditions related to an offering;
packaging by said agreement authoring tool, a copy of said revisable agreement with said offering; and
transmitting by said agreement authoring tool, said copy of said revisable agreement packaged with said offering to an agreement managing tool for revising said copy.

57. The computer program product of claim 56, wherein said agreement authoring tool comprises an authoring interface tool, and wherein said method further comprises:
generating by said agreement authoring tool, said revisable agreement; and
generating by said agreement authoring tool, at least one associated action related to said revisable agreement, wherein said at least one associated action is for said agreement managing tool to perform an action on said copy.

58. The computer program product of claim 57, wherein said agreement authoring tool further comprises a packaging tool, and wherein said method further comprises:
creating a package by said packaging tool, wherein said package comprises said offering with said copy and said at least one associated action.

59. The computer program product of claim 58, further comprising transmitting said package to said agreement managing tool.

60. The computer program product of claim 59, further comprising receiving by said agreement authoring tool, said copy from said agreement managing tool, wherein said copy has been revised by said agreement managing tool according to said at least one associated action.

61. The computer program product of claim 60, wherein said agreement authoring tool further comprises a tracking tool; and wherein said method further comprises:
registering and managing by said tracking tool, a user of said agreement managing tool.

62. The computer program product of claim 61, wherein said agreement authoring tool further comprises a process actions tool, and wherein said method further comprises:
processing by said process actions tool, said at least one associated action on said copy revised by said agreement managing tool.

63. The computer program product of claim 56, wherein said offering is selected from the group consisting of a software product and a software service.

64. The computer program product of claim 56, wherein said copy of said revisable agreement packaged with said offering is transmitted to said agreement managing interface tool over a computer network.

65. A computer program product, comprising a computer usable medium having a computer readable program code embodied therein for implementing a method, wherein said computer readable program code comprises an agreement managing tool adapted to implement the method by executing the steps of:
receiving by said agreement managing tool, a copy of a revisable agreement generated by an agreement authoring tool, wherein said copy of said revisable agreement defines a set of terms and conditions related to an offering, and wherein said copy of said revisable agreement is received packaged with said offering; and
revising said copy.

66. The computer program product of claim 65, wherein said copy comprises at least one associated action for performing an action on said copy.

67. The computer program product of claim 66, wherein said agreement managing tool comprises an agreement managing user interface tool, and wherein said method further comprises:
interfacing by said user interface tool, a user to said copy packaged with said offering.

68. The computer program product of claim 67, wherein said computer readable program code further comprises an enterprise agreement policy managing tool, and wherein said method further comprises:
defining by said enterprise agreement policy managing tool, enterprise policies related to performing said specified action on said copy.

69. The computer program product of claim 68, wherein said computer readable program code further comprises a local agreement managing tool, and wherein said method further comprises:
defining by said local agreement managing tool, local policies related to performing said specified action on said copy.

70. The computer program product of claim 69, wherein a hierarchal relationship exists such that said enterprise policies are implemented before said local policies are implemented.

71. The computer program product of claim 69, wherein said agreement managing tool further comprises an actions interface tool, and wherein said method further comprises:
performing by said actions interface tool, said action on said copy according to said enterprise policies and said local policies.

72. The computer program product of claim 71, wherein said agreement managing tool further comprises a transmission tool, and wherein said method further comprises:
transmitting by said transmission tool, said copy comprising said performed action to said agreement authoring tool.

73. The computer program product of claim 65, wherein said offering is selected from the group consisting of a software product and a software service.

74. The computer program product of claim 65, wherein said copy of said revisable agreement packaged with said offering is received by said agreement managing tool over a computer network.
